(19) United States
(12) Patent Application Publication
(10) Pub. No.: US 2002/0010694 A1
(43) Pub. Date: Jan. 24, 2002

(54) Method and system for computer assisted localization and navigation in industrial environments

(76) Inventors: Nassir Navab, Plainsboro, NJ (US); Yakup Genc, Plainsboro, NJ (US)

Correspondence Address: Siemens Corporation, Intellectual Property Department, 186 Wood Avenue South, Iselin, NJ, 08830, US

(21) Appl. No.: 09/741,581

(22) Filed: Dec. 20, 2000

Related U.S. Application Data
(60) Provisional application No. 60/172,011, filed on Dec. 23, 1999.

(51) Int. Cl. G06F 7/00

(52) U.S. Cl. 707/1

(57) ABSTRACT

A method for computer assisted localization and navigation in a defined environment, comprises the steps of: obtaining a floor map of the defined environment; placing a set of identifiable markers on the floor in given locations; determining the position of a user with respect to ones of the markers; determining the global position of the user by utilizing the floor map and the given locations; and indexing a database for data associated with the global position.

Reference is hereby made to provisional patent application Application No. 60/172,011 filed Dec. 23, 1999 in the names of Navab and Genc, and whereof the disclosure is hereby incorporated herein by reference.

The present invention relates to the field of computer assisted localization and navigation and more particularly of computer assisted localization and navigation in industrial-type environments.

A person walking in a man-made environment equipped with a wearable or portable computer may want or need to get access databases containing information about his/her surroundings. If the user wants to access data which is position dependent, one can use a camera attached to the wearable computer to determine the position of the user which, in turn, can be used as an index to a database to retrieve the desired information.

For example, a maintenance person carrying a hand-held computer with a camera attached to it may be facing a wall within which concealed electrical wiring may need to be located. The computer can automatically detect the position of the user and retrieve and display an augmented image showing where the wires are in that wall.

In accordance with an aspect of the present invention, a system will automatically determine the position of the user in order to (a) automatically access and navigate through a database containing images augmented with still or animated virtual objects and (b) direct the user through the environment to a particular location.

In accordance with another aspect of the present invention, a system involves several technology areas in augmented reality and computer vision.

Augmented reality has received attention from computer vision and computer graphics researchers. See, for example, IWAR'98. International Workshop on Augmented Reality, San Francisco, Cailf., USA, Oct. 1998; and IWAR'99. International Workshop on Augmented Reality, San Francisco, Calif., USA, October 1999.

Prior art research has been concentrated on tracking and registration . See, for example, R. Azuma, A survey of augmented reality. Presence: Teleoperators and Virtual Environments 6, 4, pages 355-385, Aug. 1997.

When a real image needs to be augmented with a virtual object, typically one has to register the scene and the object in 3D. This registration generally involves determining the pose of the camera that has captured the picture and the three-dimensional structure of the scene. When the augmentation is done interactively, one needs to track the camera, i.e., to compute for each frame the position and orientation.

Though far from being completely solved, tracking can be done in several ways. They may be classified as vision-based and non-vision-based solutions. Non-vision-based solutions include magnetic, infrared, acoustic trackers, and the like. Most of these methods are not suitable for industrial settings either due to their limited range or their operating conditions. For instance, magnetic trackers cannot operate near ferromagnetic objects.

It is herein recognized that vision-based tracking looks more attractive since it involves tracking known objects in images which is what is being augmented. The main issues here are accuracy, robustness and speed. The need for accuracy and speed arises when one wants to use head-mounted displays or see-through displays.

In accordance with another aspect of the invention, a method for computer assisted localization and navigation in a defined environment, comprises the steps of: obtaining a floor map of the defined environment; placing a set of identifiable markers on the floor in given locations; determining the position of a user with respect to ones of the markers; determining the global position of the user by utilizing the floor map and the given locations; and indexing a database for data associated with the global position.

In accordance with another aspect of the invention, method for computer assisted localization and navigation in an industrial environment, comprises constructing a database of augmented images, include at least one of still and animated images: placing a set of markers on a floor of the environment, each marker being unique so as to enable identification of a position of a user in the environment; registering positions of the markers in a corresponding floor map; automatically localizing the user by using the markers floor and a corresponding floor map; directing the user to a particular location in the environment; and accessing the database for information.

In accordance with another aspect of the invention, a method for computer assisted localization and navigation of a user in an industrial-type environment, comprises: obtaining a floor map of a site; placing a set of unique visual markers on the floor; storing location information for set of unique visual markers relative to the floor map; deriving an image of the floor by a user-carried camera; processing the image by a user-carried computer for detecting a visual marker on the floor; and calculating position and orientation of the user-carried camera with respect to the marker.

In accordance with another aspect of the invention, a method for computer assisted localization and navigation the markers comprise any of visual markers including photogrammetry markers; three-dimensional objects; three-dimensional barcodes; optical, visible, infrared or ultraviolet beacons; fluorescent markers; magnetic markers; sonar systems; radar systems; microwave beacons; microwave reflectors; physically detectable markers.

In accordance with another aspect of the invention, a method for computer assisted localization and navigation of a user in an industrial-type environment, comprises: obtaining a floor map of a site; placing a set of unique markers on the floor; storing location information for set of unique markers relative to the floor map; detecting ones of the markers by a user-carried sensor; and calculating position and orientation of the user-carried sensor by a user-carried computer with respect to the ones of the markers.

In accordance with another aspect of the invention, a method for computer assisted localization and navigation in an industrial environment, comprises an “off-line” step of constructing a database of augmented images, include at least one of still and animated images: an off-line step of placing a set of markers on a floor of the environment, each marker being unique so as to enable identification of a position of a user in the environment; an off-line step of registering positions of the markers in a corresponding floor map; an “on-line” step of automatically localizing the user by using the markers floor and a corresponding floor map; an “on-line” step of directing the user to a particular location in the environment; and an on-line step of accessing the database for information.

In accordance with another aspect of the invention, apparatus for computer assisted localization and navigation of a user in an industrial environment, comprises: apparatus for obtaining a floor data map of a site; a set of unique markers on the floor data map; a detector system for detecting the markers; and computer apparatus for determining a location of the user through the step of detecting the markers.

The invention will be more fully understood from the following detailed description of preferred embodiments, in conjunction with the drawing, in which

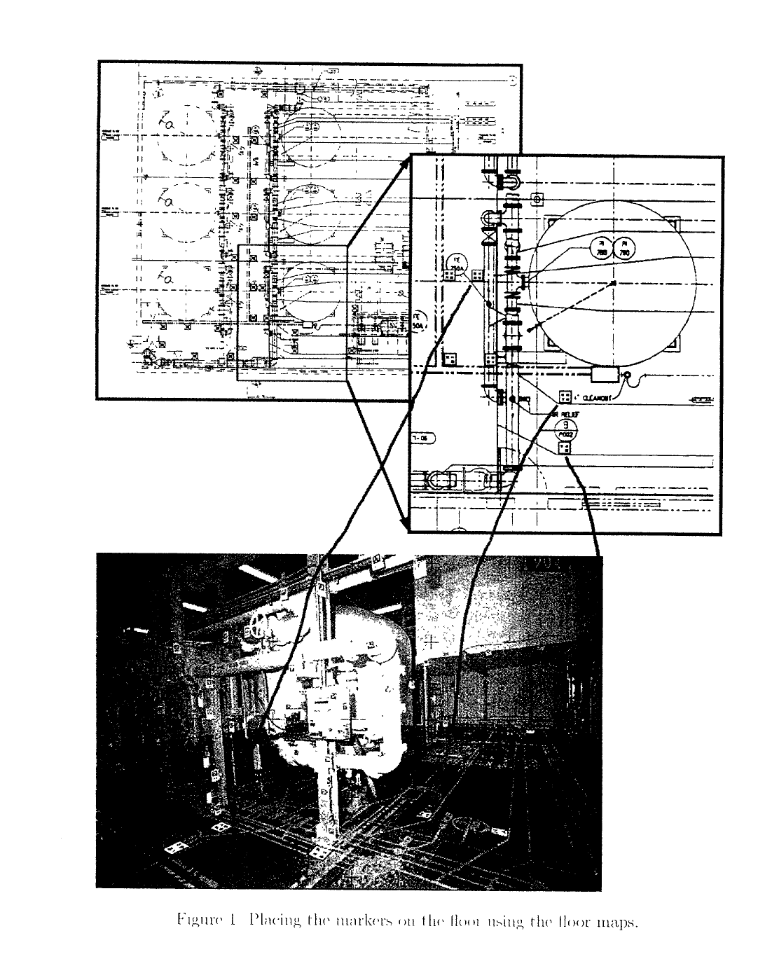

FIG. 1 shows placement of markers on a floor using floor maps in accordance with the invention;

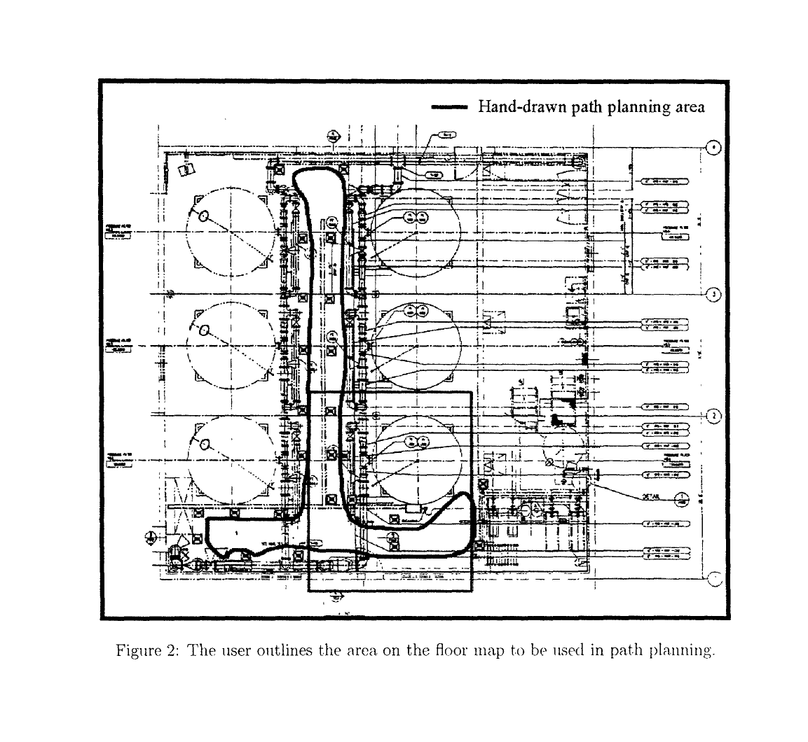

FIG. 2 shows outlines by the user on a floor map to be used in path planning in accordance with the invention;

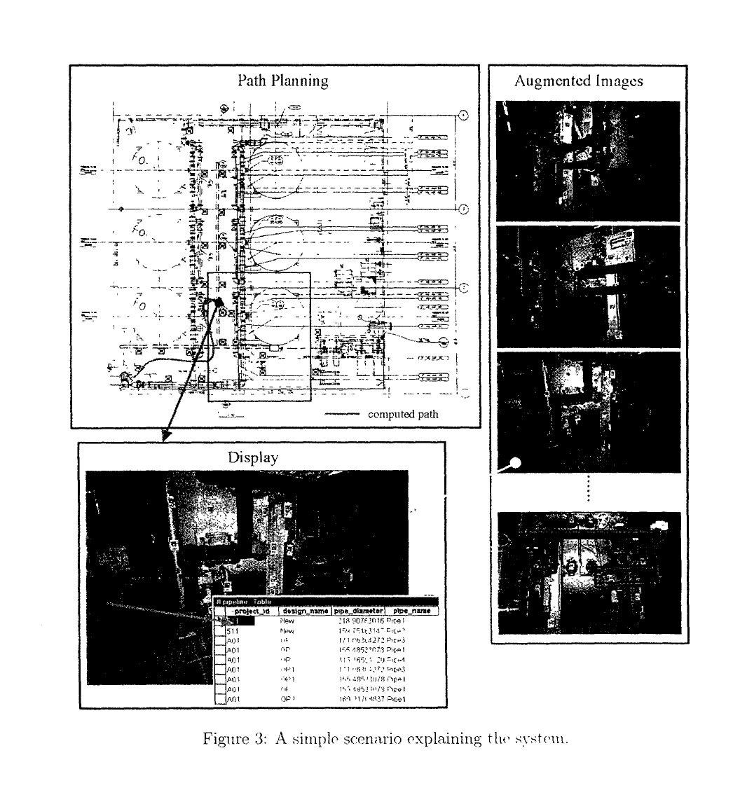

FIG. 3 shows a scenario illustrative of part of an embodiment of the invention; and

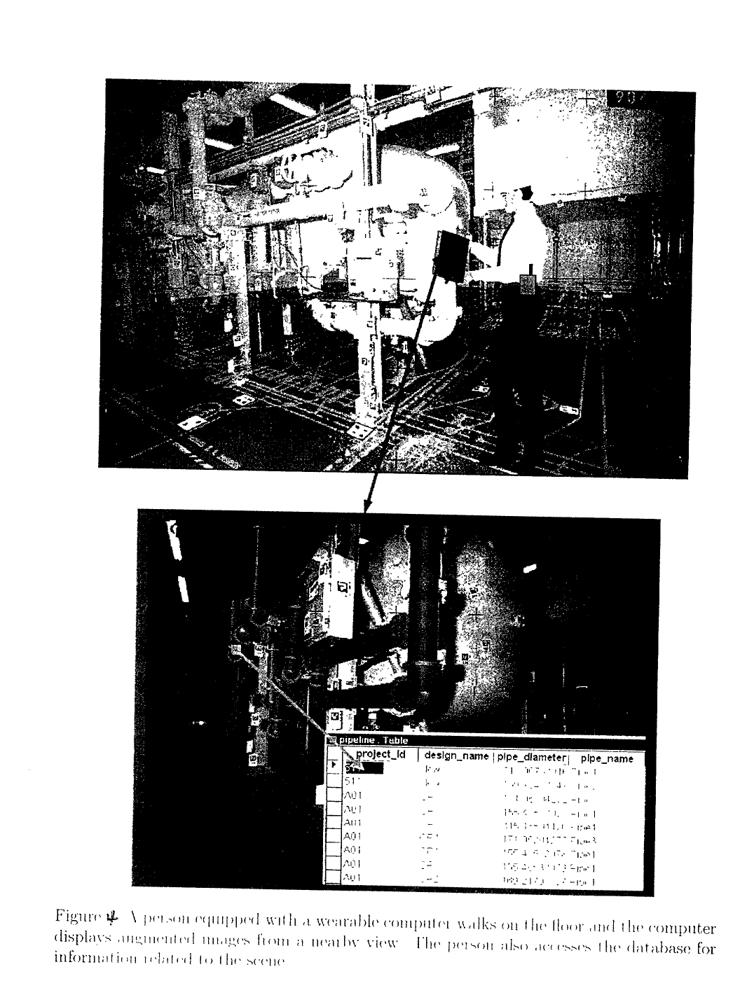

FIG. 4 shows a scene in accordance with the invention in which a person with a wearable computer walking on a floor with the computer displaying augmented images from a nearby view while the person also accesses a database for information related to the scene.

The method, system or apparatus, in accordance with the present invention simplifies the problem by relaxing the accuracy requirements in tracking and registration gaining speed and robustness. For augmented video on hand-held computers the need for accuracy can be relaxed since the video is typically retrieved from the database. Note that the video need not be directly captured and augmented on the computer. The camera is only used for localization. Furthermore, since the floor of a site is generally the least cluttered, tracking markers on the floor is easy and can be done in a fast and robust way.

For any particular application, the system in accordance with the invention will later be realized in two steps. First, an off-line step of building a database comprising augmented (still or animated) images of the environment. The first step will also include positioning markers on the floor of the site which will be used to register the user with the environment using floor maps (drawings or CAD data). See FIG. 1, for example.

The second step will be on-line where a user will walk through the environment with a camera looking directly at the floor and the system will automatically detect the markers and register the user with the environment. See FIG. 4, for example. Then, the system will either direct the user to a particular location or retrieve augmented images from the database which corresponds to the closest position to the user's current location and viewing direction. Depending on the situation, the system could retrieve animated augmented images (e.g., an image augmented with an animation describing how to perform a certain maintenance or inspection task) or still images (e.g., showing the position of the electrical wiring on a wall). The computer can also retrieve the list of items in the database which are in the field of view of the user, thus allowing a fast inventory check which can be verified visually. See FIG. 4, for example.

For off-line set-up, in accordance with an aspect of the invention, a system comprises:

A database of augmented (still or animated) images: this construction can be done using CyliCon; see for example N. Navab, N. Craft, S. Bauer, and A. Bani-Hashemi. CyliCon: A software package for 3D reconstruction of industrial pipelines. In Proc. IEEE Workshop on Applications of Computer Vision, October 1998; and N. Navab, E. Cubillo, B. Bascle, J. Lockau, K. -D. Kamsties, and M. Neuberger. CyliCon: A software platform for the creation & update of virtual factories. In Proc. International Conference on Emerging Technologies and Factory Automation, Barcelona, Catalonia, Spain, October 1999.

Placement of a set of markers (each unique to identify the position of the user in a large environment) on the floor and registration of their positions in the corresponding floor map. Integration of floor maps and images can significantly help this process. See, for example, N. Navab, B. Bascle, M. Appel, and E. Cubillo. Scene augmentation via the fusion of industrial drawings and uncalibrated images with a view to marker-less calibration. In Proc. IEEE International Workshop on Augmented Reality, San Francisco, Calif., USA, October 1999.

For on-line navigation, in accordance with another aspect of the present invention, the system comprises:

a hand-held or portable computer with a camera looking down the floor for being carrying by a user walking through the industrial site. See FIG. 4, for example.

Automatic localization of the user which is done using the markers on the floor and the corresponding floor map.

For action, in accordance with another aspect of the present invention, the system comprises:

Directing the user in the environment to a particular location.

Accessing the database for information such as drawings or animations explaining how to perform a maintenance or inspection task or the list of items around the user and their properties.

To achieve such a system, it is herein recognized that several significant issues arise; for example, these include: how to track markers placed on the floor, what scenario to retrieve from the database corresponding to the closest viewing position of the user, and how to display the retrieved augmented images. To tackle these issues, different types of methods can be used.

In accordance with an aspect of the invention, the following may be utilized:

Localization.

Construction of a large (say, greater than 500) set of unique markers to determine the position of a user in a large industrial environment.

Real-time detection and tracking of these markers which are placed on the floor.

Registration.

Computation of the position of the camera given a set of detected markers.

Database access.

Indexing the data (a still image or an animation) in the database closest to the pose of the user.

Visualization.

Rendering of the retrieved image or animation on the monitor.

Rendering intermediate views if the retrieved views are not close enough to the pose of the user.

Path planning.

Computing the shortest path in a delimited area on a plane which is highlighted on the floor map by the user.

An exemplary embodiment is next described, where the system in accordance with the present invention can be used. Suppose that in a large industrial setting a maintenance person is given the task of servicing a particular item labelled “V200”. The following sections explains how the system in accordance with an aspect of the present invention will help the person realize the goals set by the task.

The first step is the off-line step of constructing the database, setting up the markers on the floor of the site and registering the markers with the floor map or the CAD database. It is assumed that the database has already been constructed and that there is available a floor map whereby which we can place the set of unique markers on the floor. This process is depicted in FIG. 1.

Furthermore, we assume that a user highlights on the floor map the area in which the path planning can be done. Using this information, and thus omitting the three-dimensional (3-D) implications of the planned path, the computer can compute a path automatically.

An example of this is given in FIG. 2.

After the placement of the markers, a computer can track a person with a camera directly pointed at the floor. For this scenario, the localization of the person need not be exact. Augmented images from nearby viewpoints can serve the purpose of an augmented image from an exact viewing position.

When the person enters the site, he turns on his computer and enters the item number “V200” into the computer. The computer first locates where the user is. Using the floor map, it finds a path from the current location of the user to where the item is located. This path is shown on the screen. The user verifies the direction and starts walking. During the walk, the computer may monitor the progress and give warnings if the user is not on the right path. Once the user arrives in front of the item that needs to be maintained or inspected, the computer displays still or animated images showing where exactly the item is located and the process of how to maintain that item. These augmented images are constructed off-line and are obtained from a view that is the closest to the user's current pose.

FIGS. 3 and 4 illustrate the process described above.

In accordance with an embodiment of the invention, the method includes the following features:

1. Obtaining a floor map of the factory or the industrial site:

A floor map can be replaced with an industrial drawing or a CAD database.

2. Placing a set of unique markers on the floor of the site:

When these markers are detected, the location of the user will be determined uniquely as described in step 4 below. The markers can be based on any suitable technology, including but not limited to the following technologies: visual markers such as photogrammetry markers, three-dimensional objects or barcodes; infrared beacons; magnetic markers; sonar; radar; and microwave techniques. The markers are identifiable.

3. During the marker placement process, recording the actual position of the markers on the floor map:

The position of the user as explained in the last step above will be detected with respect to a marker locally. Then, global location will be determined using the position of the marker on the floor map.

4. Determining in real time the position and orientation of a user equipped with a mobile computer:

When a visual marker is used, the user carries a computer with a camera which is looking down at the floor. The image obtained from the camera is used by the computer to detect a marker on the floor and in turn to calculate the position and orientation of the camera/computer with respect to the marker from the features extracted on the marker.

When non-visual markers are used, corresponding detectors/receivers provide the position and orientation of the user with respect to the markers in the vicinity.

Once the position of the user is detected with respect to the local marker/markers, the global position is detected from the position information of the marker on the floor map which is recorded in Step 3.

5. A combination of detection techniques is used to improve the detection accuracy of the user's position and orientation. For example, if visual markers are used, an inertia sensor is used to correct any possible error in the detected orientation.

6. The position and orientation detection system is also contemplated in an embodiment of the invention.

The position and orientation of the user will be used to index databases of positional information. For example, when we have an image catalogue of a site, the computer will display on the monitor all the images of the objects in the field of view of the user.

7. With regard to general database indexing, other positional information in the databases can be indexed using the detected position. For example, a list of the items in the database that the user can see can be displayed on the monitor.

8. Path Image database or catalogue indexing using the position information obtained from the real time. Path planning and computer assisted navigation is contemplated whereby the user can be guided through an environment that is unknown to him with the help of the computer. The path planning is performed on the floor plan and the progress of the user is monitored by the computer using the position information which is detected as described in Step 4.

9. Through the use of computer assisted service and maintenance, routine or unexpected service and maintenance needs can be guided and assisted by the computer. For example, a movie of how a certain maintenance task should be performed can be displayed once the user is in the vicinity of the corresponding item that needs to be serviced.

The following are among the benefits to a customer using resulting from use of the system in accordance with the invention. Computer assisted inspection and maintenance is possible with fewer and/or less trained personnel. Fast inventory checks and updates are also a benefit.

Reference has been made in the description of preferred embodiments to positioning markers on a floor; however, while this is considered to be most practicable and convenient, it will be understood that other convenient portions of the environment may also be used for marker placement, for example, walls, equipment, and so forth.

While the invention has been described by way of exemplary embodiments, it will be understood by one of skill in the art to which it pertains that various changes and substitutions may be made without departing from the spirit of the invention which is defined by the claims following.

What is claimed is:

1. A method for computer assisted localization and navigation in a defined environment, comprising the steps of:
obtaining a floor map of said defined environment;
placing a set of identifiable markers on said floor in given locations;
determining the position of a user with respect to ones of said markers;
determining the global position of said user by utilizing said floor map and said given locations; and
indexing a database for data associated with said global position.

2. A method for computer assisted localization and navigation in a defined environment as recited in claim 1, wherein said step of obtaining a floor map comprises forming a data base.

3. A method for computer assisted localization and navigation in a defined environment as recited in claim 1, wherein said step of placing a set of identifiable markers comprises recording actual positions of said markers on said floor map.

4. A method for computer assisted localization and navigation in a defined environment as recited in claim 1, wherein said step of indexing a database for data comprises accessing data relating to objects associated with said global position.

5. A method for computer assisted localization and navigation in a defined environment as recited in claim 1, wherein said step of indexing a database for data comprises accessing data relating to objects in a perceptual environment of said global position.

6. A method for computer assisted localization and navigation in a defined environment as recited in claim 1, wherein said step of determining the position of a user with respect to ones of said markers comprises a step of identifying a marker comprising any of the following types of markers: visual markers such as photogrammetry markers, three-dimensional objects or barcodes, infrared beacons, magnetic markers, sonar, radar, and markers using microwave techniques detectable by a suitable detection method.

7. A method for computer assisted localization and navigation in an industrial environment, comprising:
constructing a database of augmented images, include at least one of still and animated images:
placing a set of markers on a floor of said environment, each marker being unique so as to enable identification of a position of a user in said environment;
registering positions of said markers in a corresponding floor map;
automatically localizing said user by using said markers floor and a corresponding floor map;
directing said user to a particular location in said environment; and
accessing said database for information.

8. A method for computer assisted localization and navigation as recited in claim 7, wherein said step of accessing said database for information comprises a step for obtaining from said database graphical items such as drawings or animations explaining how to perform a maintenance/inspection task.

9. A method for computer assisted localization and navigation as recited in claim 7, wherein said step of obtaining from said database graphical comprises obtaining retrieved views close to the pose of said user.

10. A method for computer assisted localization and navigation as recited in claim 8, wherein said step of obtaining from said database graphical comprises rendering of a retrieved image or animation on a monitor.

11. A method for computer assisted localization and navigation as recited in claim 10, wherein said step of obtaining from said database graphical items comprises rendering intermediate views if said retrieved views are not close enough to the pose of said user.

12. A method for computer assisted localization and navigation as recited in claim 8, wherein said step of automatically localizing said user by using said markers and a corresponding floor map includes a step of pointing a camera at said markers.

13. A method for computer assisted localization and navigation as recited in claim 7, including a step of computing the position of said camera, given a set of detected markers.

14. A method for computer assisted localization and navigation as recited in claim 7, wherein said step of accessing said database for information comprises a step for obtaining from said database a list of items around said user and properties of said items.

15. A method for computer assisted localization and navigation as recited in claim 7, wherein said step of accessing said database for information comprises a step for obtaining from said database a list of items around said user and properties of said items.

16. A method for computer assisted localization and navigation as recited in claim 7, wherein said step of placing a set of markers comprises constructing set of more than 500 unique markers.

17. A method for computer assisted localization and navigation as recited in claim 7, wherein said step of placing a set of markers comprises constructing set of more than 500 unique markers.

18. A method for computer assisted localization and navigation as recited in claim 7, wherein said step of automatically localizing said user by using said markers comprises a step of detecting and tracking said markers in real time.

19. A method for computer assisted localization and navigation as recited in claim 7, including a step computing the shortest path between selected points in a delimited area on a plane which is highlighted on said floor map by the user.

20. A method for computer assisted localization and navigation as recited in claim 19, wherein said step of computing the shortest path comprises steps for guiding said user with the help of said computer through an environment that is unknown to said user.

21. A method for computer assisted localization and navigation of a user in an industrial-type environment, comprising:
obtaining a floor map of a site;
placing a set of unique visual markers on said floor;
storing location information for set of unique visual markers relative to said floor map;
deriving an image of said floor by a user-carried camera;
processing said image by a user-carried computer for detecting a visual marker on said floor; and
calculating position and orientation of said user-carried camera with respect to said marker.

22. A method for computer assisted localization and navigation of a user in accordance with claim 21, wherein said step of calculating position and orientation of said user-carried camera comprises:
determining a local position of said user through said step of detecting said markers; and
determining a global location of said user by utilizing said stored location information.

23. A method for computer assisted localization and navigation of a user in accordance with claim 21, wherein said user-carried camera and said user-carried computer are arranged in an integral unit.

24. A method for computer assisted localization and navigation of a user in accordance with claim 21, including a step of planning a desired path for said user on said floor map.

25. A method for computer assisted localization and navigation of a user in accordance with claim 24, including a step of guiding a said user in accordance with said desired path by said computer utilizing said calculated position and orientation.

26. A method for computer assisted localization and navigation of a user in accordance with claim 25, including steps of:
indexing a database of positional information; and
displaying said information to said user.

27. A method for computer assisted localization and navigation of a user in accordance with claim 25, including steps of:
indexing a database of position-specific information; and
displaying said position-specific information to said user.

28. A method for computer assisted localization and navigation of a user in accordance with claim 27, wherein said step of displaying said position-specific information to said user comprises a step of displaying images of objects in the field of view of said user.

29. A method for computer assisted localization and navigation of a user in an industrial environment, comprising:
obtaining a floor data map of a site;
establishing a set of unique markers on said floor data map;
detecting said markers; and
determining a location of said user through said step of detecting said markers.

30. A method for computer assisted localization and navigation as recited in claim 29, wherein said markers comprise any of visual markers including photogrammetry markers; three-dimensional objects; three-dimensional barcodes; optical, visible, infrared or ultraviolet beacons; fluorescent markers; magnetic markers; sonar systems; radar systems; microwave beacons; microwave reflectors; physically detectable markers.

31. A method for computer assisted localization and navigation of a user in an industrial-type environment, comprising:
obtaining a floor map of a site;
placing a set of unique markers on said floor;
storing location information for set of unique markers relative to said floor map;
detecting ones of said markers by a user-carried sensor; and
calculating position and orientation of said user-carried sensor by a user-carried computer with respect to said ones of said markers.

32. A method for computer assisted localization and navigation of a user in accordance with claim 31, wherein said step of calculating position and orientation of said user-carried sensor comprises:
determining a local position of said user through said step of detecting said ones of said markers; and
determining a global location of said user by utilizing said stored location information.

33. A method for computer assisted localization and navigation of a user in accordance with claim 31, wherein said user-carried sensor and said user-carried computer are arranged in an integral unit.

34. A method for computer assisted localization and navigation of a user in accordance with claim 32, including a step of planning a desired path for said user on said floor map.

35. A method for computer assisted localization and navigation of a user in accordance with claim 34, including a step of guiding a said user in accordance with said desired path by said computer utilizing said calculated position and orientation.

36. A method for computer assisted localization and navigation of a user in accordance with claim 31, including steps of:
indexing a database of positional information; and
displaying said information to said user.

37. A method for computer assisted localization and navigation of a user in accordance with claim 36, including a step of:
displaying position-specific information to said user.

38. A method for computer assisted localization and navigation of a user in accordance with claim 37, wherein said step of displaying said position-specific information to said user comprises a step of displaying images of objects in the field of view of said user.

39. A method for computer assisted localization and navigation of a user in accordance with claim 37, wherein said step of displaying said position-specific information to said user comprises a step of displaying information on task performance relating to items at said position.

40. A method for computer assisted localization and navigation of a user in accordance with claim 31, wherein said step of calculating position and orientation of said user-carried sensor by a user-carried computer with respect to said ones of said markers includes a step of combining observations of sensors utilizing different physical characteristics for detection.

41. A method for computer assisted localization and navigation in an industrial environment, comprising:
an “off-line” step of constructing a database of augmented images, include at least one of still and animated images:
an off-line step of placing a set of markers on a floor of said environment, each marker being unique so as to enable identification of a position of a user in said environment;
an off-line step of registering positions of said markers in a corresponding floor map;
an “on-line” step of automatically localizing said user by using said markers floor and a corresponding floor map;
an “on-line” step of directing said user to a particular location in said environment; and
an on-line step of accessing said database for information.

42. Apparatus for computer assisted localization and navigation of a user in an industrial environment, comprising:
apparatus for obtaining a floor data map of a site;
a set of unique markers on said floor data map;
a detector system for detecting said markers; and
computer apparatus for determining a location of said user through said step of detecting said markers.

43. Apparatus for computer assisted localization and navigation of a user as recited in claim 42, wherein said floor data map comprises at least one of an industrial drawing and a computer-aided-design (CAD) database.

44. Apparatus for computer assisted localization and navigation of a user as recited in claim 43, wherein said floor data map comprises at least one of an industrial drawing in electronic form and a computer-aided-design (CAD) database.

45. Apparatus for computer assisted localization and navigation as recited in claim 42, wherein said markers comprise any of visual markers including photogrammetry markers; three-dimensional objects; three-dimensional barcodes; optical, visible, infrared or ultraviolet beacons; fluorescent markers; magnetic markers; sonar systems; radar systems; microwave beacons; microwave reflectors; and transponders.

46. Apparatus for computer assisted localization and navigation as recited in claim 42, including inertial sensor apparatus for enhancing accuracy of orientation data derived from said markers.
